(19) United States
(12) Patent Application Publication
(10) Pub. No.: US 2010/0094784 A1
(43) Pub. Date: Apr. 15, 2010

(54) GENERALIZED KERNEL LEARNING IN SUPPORT VECTOR REGRESSION

(75) Inventor: Manik Varma, Bangalore (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/250,527

(22) Filed: Oct. 13, 2008

(51) Int. Cl. G06F 15/18

(52) U.S. Cl. 706/12

(57) ABSTRACT

A generalized kernel learning system and method for learning a wide variety of kernels for use in a support vector regression (SVR) technique. Embodiments of the generalized kernel learning system and method learn nearly any possible kernel, subject to minor constraints. The learned kernel then is used to obtain a desired function, which is a function that closely fits training data and has a desired simplicity. Embodiments of the generalized kernel learning method include inputting the training data, reformulating a and a standard SVM ε-SVR primal formulation for a single kernel as two reformulated primal cost functions for multiple kernels, and then reformulating one of the two reformulated primal cost functions as a reformulated dual cost function. A plurality of different regularizer and kernel combinations is evaluated using the reformulated dual cost function, and it is determined which regularizer and kernel combination yields the desired function.

### BACKGROUND

Data regression analysis is a technique that models numerical training data to find a function that most closely represents the training data. Parameters of the regression are estimated so as to give a “best fit” of the data subject to prior knowledge and regularization. One type of regression is kernel regression, which is used to find a non-linear relation between a pair of random variables X and Y contained in the training data. In other words, kernel regression is an estimation technique to fit the training data.

By way of example, suppose that it is desired to estimate a function from training data. In this example, assume that the function takes a real number as input, and returns a real number as output. Further assume that the function is f(x)=x². In this particular example, the function is f, the input is x, and the output is x². The training data therefore, contains the values 1 and 2 (input “1” and output “2”), 2 and 4 (input “2” and output “4”), and so forth. Given this training data, and assuming the function is unknown, the goal is to estimate the function that most closely fits the training data.

In general, there are an infinite number of functions that will solve the problem given in the above example. Namely, while x² will solve the problem, so will many higher-order polynomials. Thus, kernel regression not only tries to estimate a function that passes through the data points as closely as possible, but also attempts to find the function that is as simple as possible. The precise technical definition of simple can be quite involved, but is known to those having ordinary skill in the art. However, in lay terms, it can be said that for the particular case of Support Vector Machines (SVMs) it is desirable to fit a function that is as “flat” as possible.

Kernel regression is a superset of local weighted regression and includes Moving Average and K nearest neighbor (KNN), radial basis function (RBF), Neural Network and SVM techniques. The standard SVM regression method is to try and fit a particular loss function to the data. A version of SVM for regression is called Support Vector Regression (SVR). One type of SVR technique is base on an epsilon-insensitive loss function (ε-insensitive loss function) and is called epsilon-SVR. The goal here is to use the ε-insensitive loss function and try to fit a straight line to the data so that the function is as “flat” as possible. “Flat” has some technical definition that is defined in the SVM literature and well known to those of ordinary skill in the art. It is desirable to find a function that is as “flat” as possible and also fits the data as closely as possible according to the ε-insensitive loss function.

A key ingredient in SVR techniques is the kernel. The kernel is a mapping that takes pairs of data points and gives the similarity between them. For example, if given two points, 0 and 1, the kernel may find that they are fairly similar, while two other points, 10 and 1,000, the kernel may find that they are not very similar. Thus, the kernel measures a similarity between a pair of data points.

Many current SVR techniques use a fixed kernel. This requires a user to specify in advance, prior to the start of the technique, the kernel function in the SVR technique. Recently, there has been some work on learning the kernel instead of using a fixed kernel. However, these kernel learning techniques are limited to learning a linear combination of given base kernels. In particular, a user is given a choice of say, ten kernels, and then the kernel is some linear combination of these ten kernels. This severely limits the types of kernels that can be learned by these current kernel learning techniques.

Current kernel learning techniques also place a specific type of regularizer on the kernel weights (where d are the kernel weights). The regularizer is a parameter that specifies the simplicity and smoothness of the function. Whenever regression is performed, the goal is to find a function that approximates the data as well as possible but also is as simple or smooth as possible. Current kernel learning techniques use only an L1 regularizer on the kernel weights, which forces most of the kernel weight values to zero. This severely restricts the values of the regularizer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the generalized kernel learning system and method learn a generic variety of kernels for use in a support vector regression (SVR) technique. Many possible kernels may be learned for evaluation in SVR techniques in order to obtain a desired function. A desired function is a function that closely fits training data and has a desired simplicity or smoothness. Embodiments of the generalized kernel learning system and method differ from existing techniques in that the kernel is learned in a general way. Embodiments of the generalized kernel learning system and method can perform kernel learning in an SVR technique (or SVM regression), but also can learn a general combination of kernels or a general kernel parameterization, subject to general regularizers. Thus, embodiments of the generalized kernel learning system and method generalize and broaden a cost function for SVM regression.

Embodiments of the generalized kernel learning system and method generalize the learning of the kernel. Any value of the kernel can be learned and use, subject to minor constraints. First, the kernel is constrained to be strictly positive definite. Second, the kernel is constrained to be differentiable with continuous derivative. Moreover, any value of the regularizer can be used, subject to the constraint that the regularizer is differentiable with continuous derivative.

Embodiments of the generalized kernel learning system input training data. The framework over which embodiments of the generalized kernel learning system and method are built is a standard support vector machine (SVM) epsilon-insensitive support vector regression (ε-SVR) primal formulation for a single kernel. The output is a desired function that closely fits the training data and has a desired simplicity and smoothness. In other words, the function that most closely fits or models the data is also the most simple is the desired function. Embodiments of the generalized kernel learning system include a reformulation module, a regularizer and kernel combination selection module, a computation module, and an optimization module. In general, the reformulation module reformulates the standard SVM ε-SVR primal formulation for a single kernel into a reformulated cost function for multiple kernels. The regularizer and kernel combination selection module selects regularizer and kernel combinations to use that will likely produce the desired function when evaluated. The computation module evaluates the regularizer and kernel combinations using the reformulated dual cost function, and the optimization module finds the desired parameter settings of the function.

Embodiments of the generalized kernel learning method include evaluating a reformulated dual cost function for a plurality of different kernel parameter settings. As stated above, the kernel and regularizer can be any values, subject to the minor constraints noted above. The method then determines which kernel combination yields the desired function, and that combination is designated as the obtained kernel combination. The obtained function may be displayed to a user, and may be used in a variety of applications where it is necessary to extrapolate/interpolate the training data to data points not contained in the training data.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the generalized kernel learning system and method disclosed herein.

FIG. 2 is a block diagram illustrating details of embodiments of the generalized kernel learning system and method shown in FIG. 1.

FIG. 3 is a flow diagram illustrating the operation of embodiments of the generalized kernel learning system and method shown in FIGS. 1 and 2.

FIG. 4 is a flow diagram illustrating the detailed operation of embodiments of the reformulation module shown in FIG. 2.

FIG. 5 is a flow diagram illustrating the detailed operation of embodiments of the regularizer and kernel combination selection module shown in FIG. 2.

FIG. 6 is a flow diagram illustrating the detailed operation of embodiments of the computation module shown in FIG. 2.

FIG. 7 illustrates an example of a suitable computing system environment in which embodiments of the generalized kernel learning system and method shown in FIGS. 1-6 may be implemented.

### DETAILED DESCRIPTION

In the following description of embodiments of the generalized kernel learning system and method reference is made to the accompanying drawings, which form a part thereof, and in which is shown by way of illustration a specific example whereby embodiments of the generalized kernel learning system and method may be practiced. It is to be understood that other embodiments may be utilized and structural changes may be made without departing from the scope of the claimed subject matter.

### I. System Overview

Embodiments of the generalized kernel learning system and method include general way of learning a kernel for SVR techniques. Embodiments of the generalized kernel learning system and method differ from existing kernel learning techniques in that a more general and widespread combination of kernels can be learned. Embodiments of the generalized kernel learning system and method generalize or broaden a cost function for SVR techniques.

Embodiments of the generalized kernel learning system and method can be used in several machine learning applications. These applications include natural language processing, syntactic pattern recognition, search engines, medical diagnosis, bioinformatics, brain-machine interfaces and cheminformatics, detecting credit card fraud, stock market analysis, classifying DNA sequences, speech and handwriting recognition, object recognition in computer vision, game playing and robot locomotion. The function obtained from embodiments of the generalized kernel learning system and method can be output directly into a machine learning system or displayed to a user (such as displayed to a user on a display device) for manual input into a machine learning system.

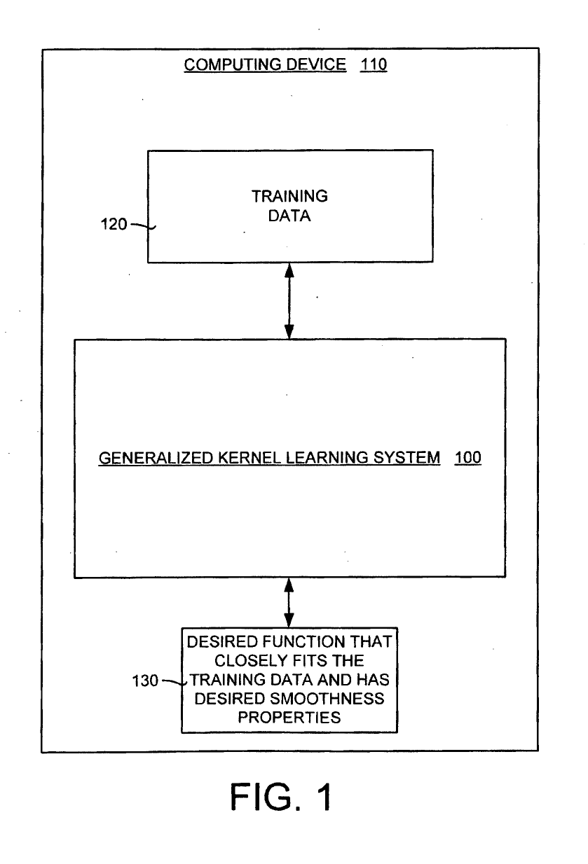

FIG. 1 is a block diagram illustrating a general overview of embodiments of the generalized kernel learning system and method disclosed herein. It should be noted that the implementation shown in FIG. 1 is only one of many implementations that are possible. Referring to FIG. 1, a generalized kernel learning system 100 is shown implemented on a computing device 110. It should be noted that the computing device 110 may include a single processor (such as a desktop or laptop computer) or several processors and computers connected to each other.

In general, embodiments of the generalized kernel learning system 100 inputs training data 120. The training data 120 contains the data for which it is desired to find a function that most closely fits the data and is as simple as possible. The output of the generalized kernel learning system 100 is a desired function 130 that closely fits the data and has the desired smoothness properties. In other words, the output of the system is a function that most closely fits the data and is as simple as possible. As explained in detail below, the function is obtained by using a process that is built on an ε-insensitive loss function. The primal formulation of the ε-insensitive loss function has a fixed kernel and is the starting point for finding the function 130.

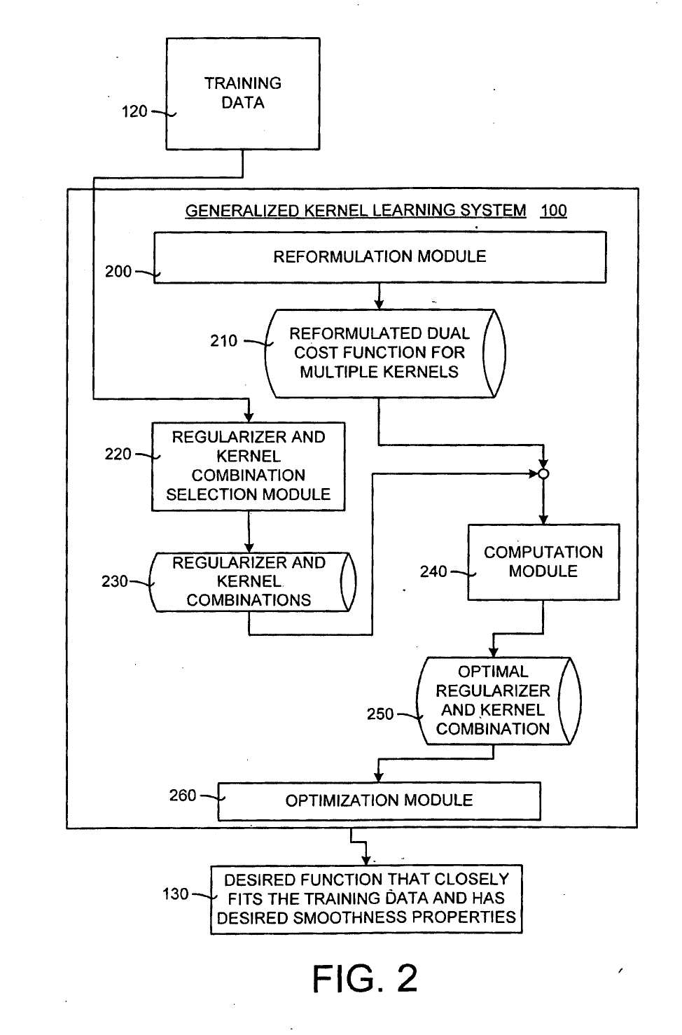

FIG. 2 is a block diagram illustrating details of embodiments of the generalized kernel learning system 100 and method shown in FIG. 1. As noted above, the input to the system 100 is the training data 120. Embodiments of the generalized kernel learning system 100 include a reformulation module 200 for reformulating the primal formulation of the ε-insensitive loss function. In particular, the output of the reformulation module 200 is a reformulated dual cost function for multiple kernels 210. As explained in detail below, this reformulated dual cost function 210 a reformulated dual cost function that is obtained from one of two reformulated primal cost functions.

Embodiments of the generalized kernel learning system 100 also include a regularizer and kernel combination selection module 220. As explained in detail below, the module 220 finds the regularizer and kernel combination that will produce the desired function 130 that most closely fits the data and has the desired smoothness properties. The output of the regularizer and kernel combination selection module 220 is regularizer and kernel combinations 230.

The regularizer and kernel combinations 230 and training data 120 are input to a computation module 240. As explained in detail below, the computation module 240 evaluates the different regularizer and kernel combinations 230 in the reformulated dual cost function for multiple kernels 210 until the optimal regularizer and kernel combination is found that is likely to produce the desired function 130 that closely fits the data and has the desired smoothness properties. The output of the computation module 240 is an optimal regularizer and kernel combination 250. This optimal combination 250 is sent to an optimization module 260, where the desired function 130 that closely fits the data and has the desired smoothness properties is found and output from the system 100.

### II. Operational Overview

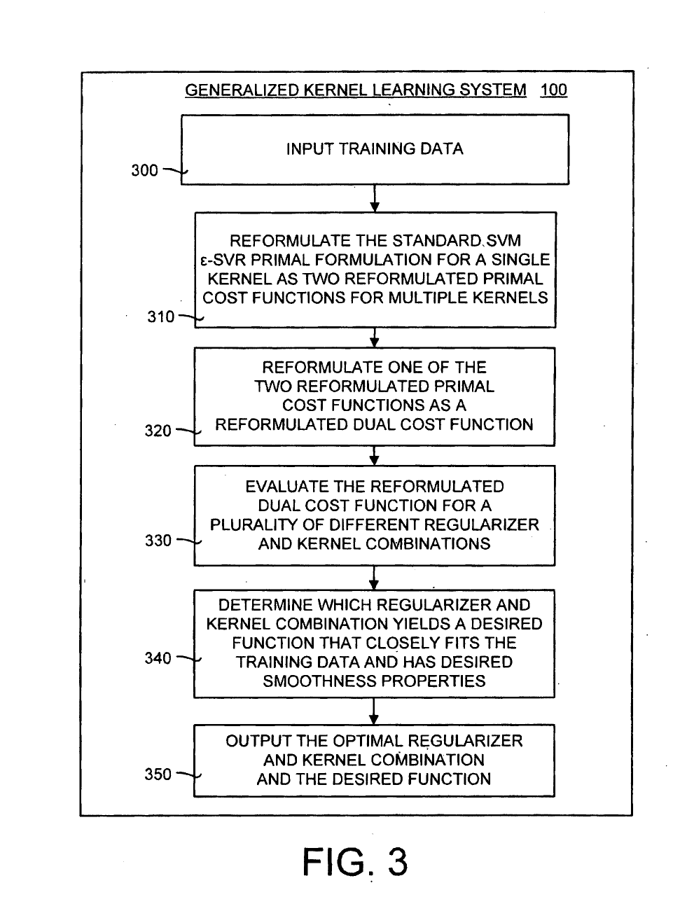

FIG. 3 is a flow diagram illustrating the operation of embodiments of the generalized kernel learning system 100 and method shown in FIGS. 1 and 2. The method begins by inputting training data (box 300). Next, the method reformulates a standard SVM ε-SVR primal formulation for a single kernel as two reformulated primal cost functions for multiple kernels (box 310). As explained in detail below, this reformulation includes multiple kernelizing the primal formulation for the single kernel.

The method then reformulates one of the two reformulated primal cost functions as a reformulated dual cost function (box 320). As explained below, this reformulated dual cost function is the dual version of one of the reformulated primal cost functions. Next, the method evaluates the reformulated dual cost function for a plurality of different regularizer and kernel combinations (box 330). This iterative process is performed until the optimal regularizer and kernel combination is found that yields a desired function (box 340). This desired function is one that closely fits the training data, has the desired simplicity, and has the desired smoothness properties. The output of the method is the optimal regularizer and kernel combination and the desired function (box 350).

### III. Operational Details

The operational details of embodiments of the generalized kernel learning system 100 and method now will be discussed. These embodiments include embodiments of the program modules shown in FIG. 2. The operational details of each of these programs modules now will be explained in detail.

### III.A. Reformulation Module

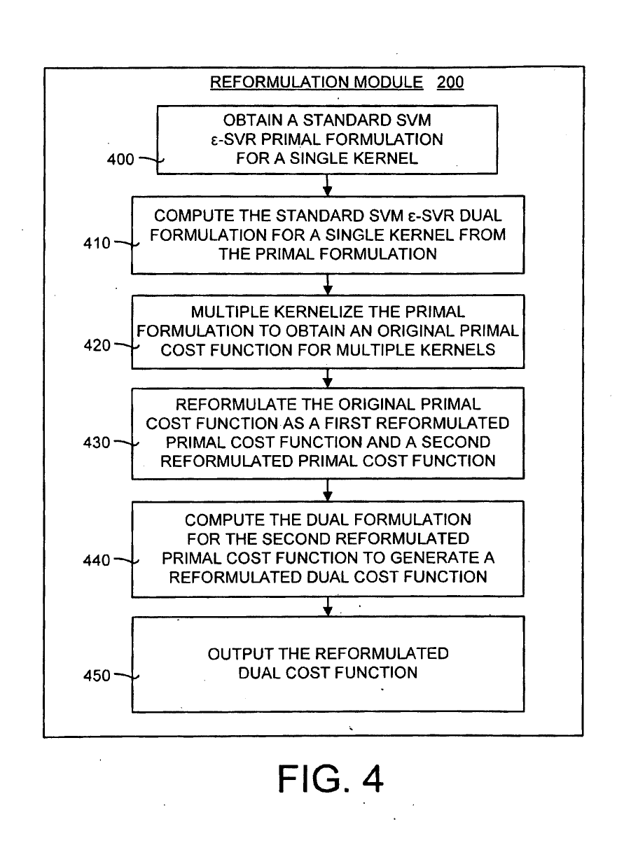

FIG. 4 is a flow diagram illustrating the detailed operation of embodiments of the reformulation module 200 shown in FIG. 2. In general, the reformulation module 200 starts from a primal formulation for single kernels and produces two reformulated dual cost functions for multiple kernels. In the subsequent discussion, it should be noted that the variable K refers to a kernel and the variable d is a kernel weight. The process as to how this reformulation is accomplished is set forth as follows.

### III.A.1.Single Kernel Regression

In this section, the formulations of the standard ε-SVR, v-SVR, and ordinal regression problems are set forth when the kernel is pre-specified. To fix the notation, the training data is denoted by,

{(xᵢ,yᵤ)ᵢ₌₁^{N}}.

and,

K(xᵢ,xⱼ)=φ^{t}(xᵢ)φ(xⱼ)

evaluates the given kernel for the points xᵢ and xⱼ. Moreover, it is assumed that the user has specified the parameters C, ε, and v.
III.A.1.a. The ε-SVR for Single Kernel Regression

The goal in ε-SVR is to learn a function f which, given an input x ∈ χ, predicts the value of a related quantity, y ∈ [symbol] . The function is learned to be as flat as possible (to help generalization) while simultaneously minimizing the prediction error on the training set. In ε-SVR, error is measured in terms of the ε-insensitive loss function which (linearly) penalizes only those predictions that are off by more than ε. The user defined parameter C>0 is a trade-off between generalization and fit to the training data. If f takes the form,

f(x)=w^{t}φ(x)+b.

then the function can be learned by solving the following primal optimization problem:

$$\begin{matrix}{Min}_{w , b , {ξ}^{\pm }} \frac{1}{2} {w}^{t} w + C {1}^{t} ( {ξ}^{+} + {ξ}^{-} ) \\ subject to & ( 1 ) \\ \pm ( {w}^{t} φ ( {x}_{i} ) + b - {y}_{i} ) \leq ε + {ξ}_{i}^{\pm } & ( 2 ) \\ {ξ}^{\pm } \geq 0. & ( 3 )\end{matrix}$$

Referring to FIG. 4, the reformulation module 200 obtains a standard SVM ε-SVR primal formulation for a single kernel (box 400). This standard SVM ε-SVR primal formulation for a single kernel is given by Equations (1), (2), and (3) above.

The method then computes the SVM ε-SVR dual formulation for a single kernel from the primal formulation (box 410). In particular, the corresponding dual problem for the standard SVM ε-SVR primal formulation is:

$$\begin{matrix}{Max}_{{α}^{\pm }} - \frac{1}{2} {( {α}^{-} - {α}^{+} )}^{t} K ( {α}^{-} - {α}^{+} ) + {y}^{t} ( {α}^{-} - {α}^{+} ) - {ε1}^{t} ( {α}^{-} + {α}^{+} ) \\ subject to & ( 4 ) \\ {1}^{t} ( {α}^{-} - {α}^{+} ) = 0 , 0 \leq {α}^{\pm } \leq C & ( 5 )\end{matrix}$$

where f can now be expressed as,

f(x)=Σᵥ(αᵢ⁻−αᵢ⁺)^{t}K(xᵢ, x)+b.

III.A.1.b. The v-SVR

In v-SVR, the insensitivity parameter ε is learned rather than pre-specified. A parameter, v>0, can be provided instead that is an upper bound on the number of errors and a lower bound on the number of support vectors. The standard v-SVR primal formulation is:

$$\begin{matrix}{Min}_{w , b , {ξ}^{\pm } , ∈} \frac{1}{2} {w}^{t} w + C {1}^{t} ( {ξ}^{+} + {ξ}^{-} ) + Cv ε \\ subject to & ( 6 ) \\ \pm ( {w}^{t} φ ( {x}_{i} ) + b - {y}_{i} ) \leq ε + {ξ}_{i}^{\pm } & ( 7 ) \\ {ξ}^{\pm } \geq 0 , ε \geq 0. & ( 8 )\end{matrix}$$

The corresponding dual is:

$$\begin{matrix}{Max}_{{α}^{\pm }} - \frac{1}{2} {( {α}^{-} - {α}^{+} )}^{t} K ( {α}^{-} - {α}^{+} ) + {y}^{t} ( {α}^{-} - {α}^{+} ) \\ subject to & ( 9 ) \\ {1}^{t} ( {α}^{-} - {α}^{+} ) = 0 , 0 \leq {α}^{\pm } \leq C & ( 10 ) \\ {1}^{t} ( {α}^{-} + {α}^{+} ) \leq Cv & ( 11 )\end{matrix}$$

where the expression for f remains unchanged as,

f(x)=Σᵢ(αᵢ⁻−αᵢ⁺)^{t}K(xᵢm x)+b.

### III.A.2.Multiple Kernel Regression

In this section, multiple kernel extensions of the ε, v and ordinal support vector regression problems are formulated and it is shown how they can all be solved by a general, large scale algorithm. The theory is developed for generic kernel combinations subject to regularization. It is also shown that under a suitable choice of priors, the proposed formulation is consistent with a maximum a posteriori estimate of the parameters.

The following Lemma is introduced, which will come in handy for determining the gradient descent direction in the large scale algorithm.

Lemma 3.1: Let W be a differentiable function of d defined as:

$$\begin{matrix}W ( d ) = {Max}_{x} \frac{1}{2} {x}^{t} H ( d ) x + {f}^{t} ( d ) x + l ( d ) \\ subject to & ( 12 ) \\ Px = u & ( 13 ) \\ Qx \leq v & ( 14 )\end{matrix}$$

and let x· be the value of x at the global optimum. Even though x· is a function of d, the derivative of W with respect to d can be calculated as if x· did not depend on d. In mathematical terms,

$$\frac{\partial W}{\partial {d}_{k}} = \frac{1}{2} {x}_{*}^{t} \frac{\partial H}{\partial {d}_{k}} {x}_{*} + \frac{\partial {f}^{t}}{\partial {d}_{k}} {x}_{*} + \frac{\partial l}{\partial {d}_{k}} \qquad ( 15 )$$

Proof: Let x· be the optimal value of x. Then,

$$\begin{matrix}W ( d ) = \frac{1}{2} {x}_{*}^{t} {Hx}_{*} + {f}^{t} {x}_{*} + l & ( 16 ) \\ ⇒ \frac{\partial W}{\partial {d}_{k}} = \frac{1}{2} {x}_{*}^{t} \frac{\partial H}{\partial {d}_{k}} {x}_{*} + \frac{\partial {f}^{t}}{\partial {d}_{k}} {x}_{*} + \frac{\partial l}{\partial {d}_{k}} + ( {x}_{*}^{t} H + {f}^{t} ) \frac{\partial {x}_{*}}{\partial {d}_{k}} & ( 17 )\end{matrix}$$

The Lemma will be proved if it can be shown that:

$$δ = ( {x}_{*}^{t} H + {f}^{t} ) \frac{\partial {x}_{*}}{\partial {d}_{k}} = 0.$$

In order to prove the above Lemma, use is made of the Lagrangian and the Karush-Kuhn-Tucker (KKT) conditions. The Lagrangian is given by,

$$L = - \frac{1}{2} {x}^{t} Hx - {f}^{t} x - l + {λ}^{t} ( Px - u ) + {γ}^{t} ( Qx - v ) \qquad ( 18 )$$

while the necessary conditions for optimality yield,

∇ₓL(x_{*},λ_{*}, γ_{*})=0 [symbol] x·H+f=λₓ^{t}P+γₓ^{t}Q (19)

This implies that δ can now be expressed in terms of the Lagrange multipliers as,

$$δ = ( {λ}_{*}^{t} P + {γ}_{*}^{t} Q ) \frac{\partial {x}_{*}}{\partial {d}_{k}} .$$

The first term in,

$$δ \cdot {λ}_{*}^{t} P \frac{\partial {x}_{*}}{\partial {d}_{k}} .$$

can be shown to be zero by noting that, from Equation (13),

$${Px}_{*} = u ⇒ P \frac{\partial {x}_{*}}{\partial {d}_{k}} = 0 ⇒ {λ}_{*}^{t} P \frac{\partial {x}_{*}}{\partial {d}_{k}} = 0. \qquad ( 20 )$$

The second term in δ,

$${γ}_{*}^{t} Q \frac{\partial {x}_{*}}{\partial {d}_{k}} ,$$

can also be shown to be zero by applying the complimentary slackness conditions,

Yₜ(Qᵢx_{*}−vᵢ)=0

where Qᵢ represents the ith row of Q. These conditions imply that for any i, either

Y₄₂=0 or Qᵢxᵣ−rₜ=0.

The indices for which,

Y_{*i}=0

will not contribute to,

$${γ}_{*}^{t} Q \frac{\partial {x}_{*}}{\partial {d}_{k}} .$$

Of the remaining indices, there is,

$${γ}_{*}^{t} Q \frac{\partial {x}_{*}}{\partial {d}_{k}} = - \frac{\partial {γ}_{{*}_{t}}}{\partial {d}_{k}} ( {Q}_{i} {x}_{*} - {υ}_{i} ) = 0$$

$$since$$

$${Q}_{i} {x}_{*} - {υ}_{i} = 0.$$

Thus, δ=0 and the derivatives of W can be calculated as if x· was not a function of d. The proof holds even if one or both of the constraints, Equation (13) and Equation (14), are removed.

III.A.2.a. The Multiple Kernel Extension for the ε-SVR Problem

Embodiments of the generalized kernel learning system 100 and method include a multiple kernel extension of the ε-SVR problem introduced above. It is shown that a conic combination of base kernels subject to I₁ regularization leads to a Quadratically Constrained Quadratic Program (or QCQP). Next, a large scale reformulation based on projected gradient descent is developed. This large scale reformulation is much more efficient while also admitting more general kernel combinations and regularization.

Referring again to FIG. 4, the reformulation module 200 then multiple kernelizes the primal formulation to obtain an original primal cost function for multiple kernels (box 420). Specifically, embodiments of the generalized kernel learning system 100 and method generate the following primal cost function formulation to deal with the case when the kernel is no longer fixed:

$$\begin{matrix}{Min}_{w , b , d , {ξ}^{\pm }} \frac{1}{2} {w}^{t} w + C {1}^{t} ( {ξ}^{+} + {ξ}^{-} ) + l ( d ) \\ subject to & ( 21 ) \\ \pm ( {w}^{t} {φ}_{d} ( {x}_{i} ) + b - {y}_{i} ) \leq ε + {ξ}_{i}^{\pm } & ( 22 ) \\ {ξ}^{\pm } \geq 0 , d \geq 0 & ( 23 )\end{matrix}$$

where both the regularizer I and the kernel K, given by,

K(xᵢ, xⱼ)=φ_{d}^{t}(xᵢ)φ_{d}(xⱼ)

are differentiable functions of d with continuous derivative. Equations (21), (22), and (23) are called the original primal cost function for multiples kernels.

The case of I₁ regularization of a conic combination of base kernels (in other words, where I(d)=o^{t}d and K=Σₖdₖ_{K}ₖ, leads to a QCQP dual formulation of the cost function which can be solved for small problems by off-the-shelf numerical optimization packages. However, other choices of regularizers and kernel functions do not yield dual formulations that can be cast straight forwardly as QCQPs. Furthermore, QCQPs do not scale well to large problems. The generalized kernel learning system and method addresses both these issues by reformulating the optimization as a two-stage process.

### III.A.2.a.1. Large-Scale Reformulation

The large-scale optimization for multiple kernel regression used by embodiments of the generalized kernel learning system 100 and method follow a nested two-stage iterative approach. For the first stage, in an outer loop the kernel is learned by optimizing over the kernel parameters d. For the second stage, in an inner loop the kernel is held fixed and the SVR parameters α^{±} are optimized.

Referring again to FIG. 4, the reformulation module 200 reformulates the original primal cost function into two primal cost functions. The module 200 produces a first reformulated cost function and a second reformulated primal cost function (box 430). In particular, the primal is reformulated as the first reformulated primal cost function:

Min_{d} T(d) subject to d≧0, (24)

and the second reformulated primal cost function, where,

$$\begin{matrix}T ( d ) = {Min}_{w , b , {ξ}^{\pm }} \frac{1}{2} {w}^{t} w + C {1}^{t} ( {ξ}^{+} + {ξ}^{-} ) + l ( d ) \\ subject to & ( 25 ) \\ \pm ( {w}^{t} φ ( {x}_{i} ) + b - {y}_{i} ) \leq ε + {ξ}_{i}^{\pm } & ( 26 ) \\ {ξ}^{\pm } \geq 0 & ( 27 )\end{matrix}$$

The strategy used by embodiments of the generalized kernel learning system 100 and method is to optimize the reformulated problem using a projected gradient descent. In other words, this is performed by iterating over,

dⁿ+1=dⁿ−sⁿ∇_{d}T,

taking care to ensure that solutions remain in the feasible set. It should be noted that using this approach it is straight forward to incorporate additional constraints on d arising from prior knowledge as long as projection on to the feasible set is a viable operation.

In order to use gradient descent, embodiments of the generalized kernel learning system and method first prove that ∇_{d}T, exists and then calculate it. In order to do this, embodiments of the generalized kernel learning system 100 and method turn to the dual formulation of T. Referring to FIG. 4, the reformulation module 200 then computes the dual formulation for the second reformulated primal cost function (Equations (25), (26), and (27)) to generate a reformulated dual cost function (box 440). This reformulated dual cost function is given by:

$$\begin{matrix}W ( d ) = {Max}_{{α}^{\pm }} - \frac{1}{2} {( {α}^{-} - {α}^{+} )}^{t} K ( {α}^{-} - {α}^{+} ) + l ( d ) + {y}^{t} ( {α}^{-} - {α}^{+} ) - ε {1}^{t} ( {α}^{-} + {α}^{+} ) & ( 28 ) \\ subject to & \\ {1}^{t} ( {α}^{-} - {α}^{+} ) = 0 , 0 \leq {α}^{\pm } \leq C . & ( 29 )\end{matrix}$$

The output of the reformulation module 200 is the reformulated dual cost function (box 450).

It can be shown that if,

$$\frac{\partial K}{\partial d} and \frac{\partial l}{\partial d}$$

exist and are continuous and if K is strictly positive definite then,

∇_{d}W

must exist according to Danskin's Theorem. Note that only very mild restrictions have been placed on K and L. To evaluate the gradient, it is noted that by the principle of strong duality,

∇_{d}T=∇_{d}W.

Furthermore, by a straight forward application of Lemma 3.1 given above, it can be shown that,

$$\frac{\partial W}{\partial {d}_{k}} = \frac{\partial l}{\partial {d}_{k}} - \frac{1}{2} {( {α}_{*}^{-} - {α}_{*}^{+} )}^{t} \frac{\partial K}{\partial {d}_{k}} ( {α}_{*}^{-} - {α}_{*}^{+} ) .$$

Therefore, in order to calculate,

∇T,

all that is needed is to obtain α*^{±}. Since I(d) is independent of α^{±} it can be dropped from the dual optimization. As a result, W is the standard ε-SVR dual formulation and a large scale optimizer of choice can be used to obtain α*^{±} efficiently.

The learned regression function now can be expressed as,

f(x)=Σᵢ(α*ᵢ⁻−α*ᵢ⁺)^{t}K*(xᵢ, x)+b*

where K* is the kernel corresponding to the optimal setting of the parameters d*.

### III.B. Regularization and Kernel Combination Selection Module

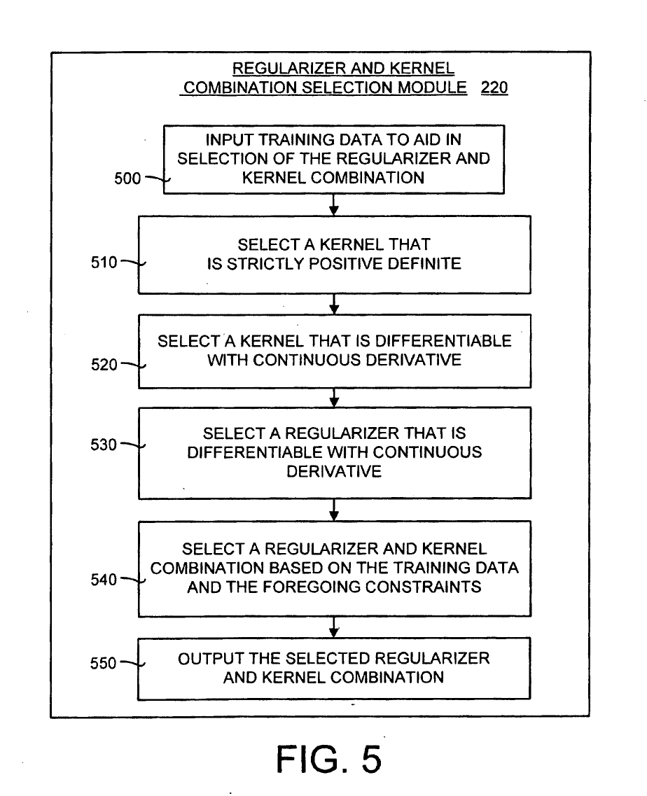

FIG. 5 is a flow diagram illustrating the detailed operation of embodiments of the regularizer and kernel combination selection module 220 shown in FIG. 2. In general, the regularizer and kernel combination selection module 220 finds the optimal regularizer and kernel combination that will produce will produce the desired function that closely fits the data and has the desired smoothness properties. The module 220 inputs the training data to aid in the selection of the regularizer and kernel combination (box 500).

Embodiments of the generalized kernel learning system 100 can learn general choices of kernels. In particular, embodiments of the system 100 allow for a general way of learning the kernel. There are some restrictions on the type of kernel that can be learned, but these restrictions are fairly minimal. One restriction is that the module 220 selects a kernel that is strictly positive definite (box 510). Another restriction is that the module 220 selects a kernel that is differentiable with continuous derivative (box 520).

More specifically, with regards to the choice of kernel K(d), embodiments of the generalized kernel learning system 100 and method require that it be strictly positive definite for all valid d and that,

∇_{d}K

exists and be continuous. Many kernels can be constructed that satisfy these properties. In particular, both sums of base kernels as well as products of base kernels (or any mix of the two) can be learned in this framework.

The general rule for the module 220 is that the kernel, K, can be any parametric function of the kernel weights, d, as long as it satisfies the above conditions. By way of example, many techniques use K(d)=Σdₖbₖkₖ. This is an acceptable for the kernel when using the module 220. In addition, by way of example, the kernel can also be combined in a product fashion as,

K(xᵢ, xⱼ)=ΠₖKₖ(xᵢ, xⱼ)=Πₖe^{-γ}^{ₖ}^{f}^{ₖ}^{(x}^{ᵢ}^{, x}^{ⱼ₎}

with the parameters γk being learned by the system 100.

The only constraints that embodiments of the generalized kernel learning system 100 and method have been imposed on the regularizer I are that its derivative does exist and is continuous. The module 220 enforces this by selecting a regularizer that is differentiable with continuous derivative (box 530). Since d is restricted to the non-negative orthant, various forms of p-norm regularizers with p≧1 fall in this category. In particular, I₁ regularization with I(d)=σ^{t}d can lead to most of the components of d being set to zero (depending on σ). This can be used for kernel and feature selection. However, when only a small number of relevant kernels or features are present, or if prior knowledge about the values of d is available, then is may be desirable to use I₂ regularization of the form,

$$l ( d ) = \frac{1}{2} {( d - μ )}^{t} {Σ}^{- 1} ( d - μ ) .$$

The general rule for the module 220 is that the regularizer, I, can be any value as long as it satisfies the above condition.

The module 220 then selects a regularizer and kernel combination based on the training data and the foregoing constraints of the values of the regularizer and kernel (box 540). The output of the module 220 is the selected regularizer and kernel combination (box 550).

The price paid for such generality of the kernel and the regularizer is that the overall formulation created by embodiments of the generalized kernel learning system and method is no longer convex. In particular, for sums of kernels and convex regularizers (such as I₁ or I2) the formulation can be made convex by a simple change of variable without affecting the dual formulation. However, for sums of products of kernels and other general combinations, even this is not possible. Nevertheless, it has been observed that this lack of convexity does not appear to have any major impact on applications that use the generalized kernel cost function generated by embodiments of the generalized kernel learning system 200 and method.

### III.C. Computation Module

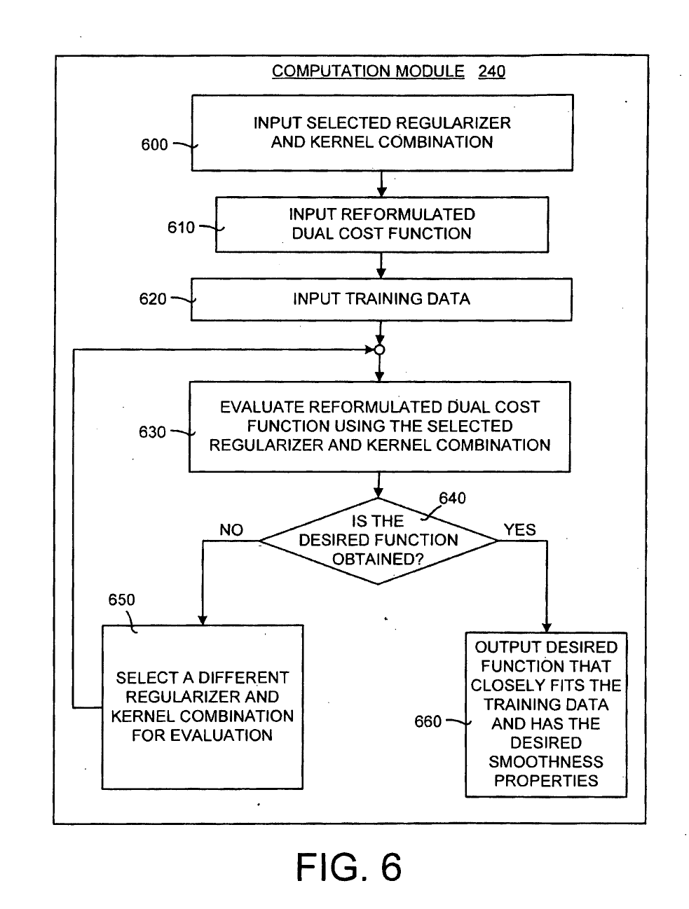

FIG. 6 is a flow diagram illustrating the detailed operation of embodiments of the computation module 240 shown in FIG. 2. In general, the computation module 240 evaluates the different regularizer and kernel combinations 230 in the reformulated dual cost function for multiple kernels 210 until the optimal regularizer and kernel combination is found that is likely to produce the desired function 130 that closely fits the data and has the desired smoothness properties.

The module 240 inputs the selected regularizer and kernel combination (box 600), the reformulated dual cost function (box 610), and the training data (box 620). Next, the module 240 evaluates the reformulated dual cost function using the selected regularizer and kernel combination (box 630). A determination then is made as to whether the desired function has been obtained (box 640). If not, then a different regularizer and kernel combination is selected for evaluation (box 650), and the evaluation is made (box 630). If the desired function is obtained, then the computation module 240 outputs the desired function, which is a function that closely fits the training data and has the desired smoothness and simplicity properties (box 660).

### III.D. Alternate Embodiments

Optimizing our formulation can also be interpreted as a maximum a posteriori (or MAP) estimation of kernel and SVR parameters. This MAP estimation corresponds to the following prior and likelihood distributions:

$$\begin{matrix}p ( {y}_{i} \vert {x}_{i} , α , b , d ) = \frac{1}{2 ( 1 + ε )} {e}^{- Max ( 0 , \vert b - {α}^{t} K ( \cdot {x}_{i} ) - {y}_{i} \vert - ε )} & ( 30 ) \\ p ( α \vert d ) = \sqrt{\vert ( λ / 2 π ) {K}_{d} \vert} {e}^{- \frac{λ}{2} {α}^{t} {K}_{d} α} & ( 31 ) \\ p ( d ) = \{ \begin{matrix}const \cdot {e}^{- λ l ( d )} & if d \geq 0 \\ 0 & otherwise\end{matrix} & ( 32 ) \\ p ( b ) = const & ( 33 )\end{matrix}$$

which, on forming the negative log posterior and setting C=1/λ, leads to the following optimization:

$${Min}_{α , b , d} C {\sum }_{i} Max ( 0 , \vert b - {α}^{t} {K}_{d} ( \cdot {x}_{i} ) - {y}_{i} \vert - ε ) + \frac{1}{2} {α}^{t} {K}_{d} α + l ( d ) - \frac{C}{2} log \vert {K}_{d} \vert \qquad ( 34 )$$

which, apart from the additional (C/2) log |K_{d}| term is identical to the above ε-SVR primal formulation. It should be noted that the addition of this term also makes the objective function similar to the marginal likelihood optimized in Gaussian Process Regression.

### IV. Exemplary Operating Environment

Embodiments of the generalized kernel learning system 100 and method are designed to operate in a computing environment. The following discussion is intended to provide a brief, general description of a suitable computing environment in which embodiments of the generalized kernel learning system 100 and method may be implemented.

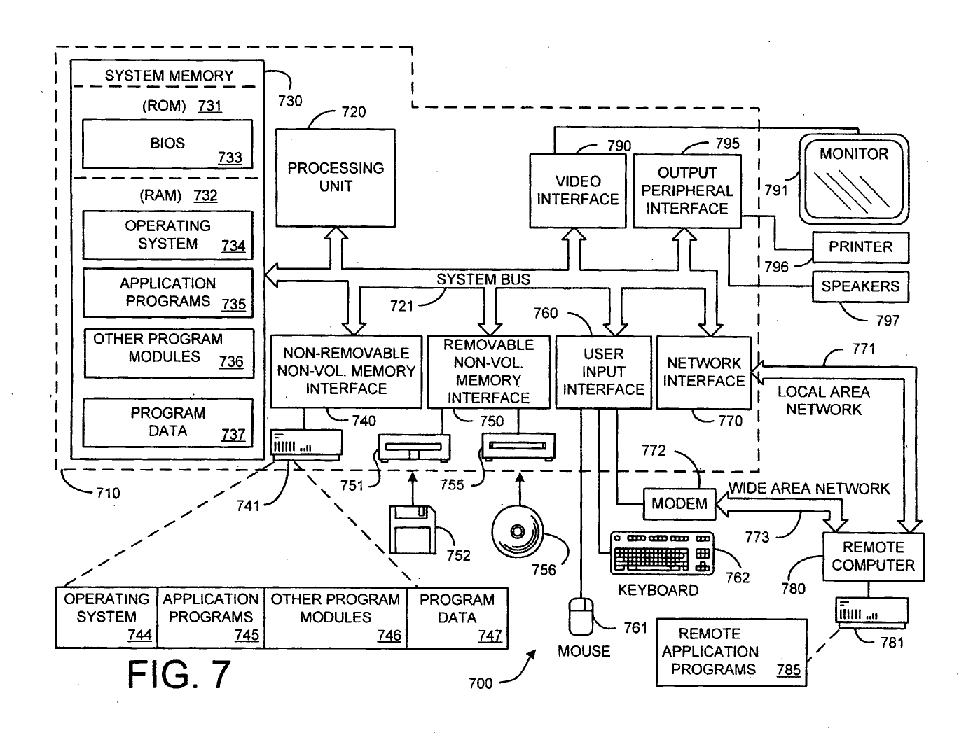

FIG. 7 illustrates an example of a suitable computing system environment in which embodiments of the generalized kernel learning system 100 and method shown in FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment.

Embodiments of the generalized kernel learning system 100 and method are operational with numerous other general purpose or special purpose computing system environments or configurations. Examples of well known computing systems, environments, and/or configurations that may be suitable for use with embodiments of the generalized kernel learning system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the generalized kernel learning system 100 and method may be described in the general context of computer-executable instructions, such as program modules, being executed by a computer. Generally, program modules include routines, programs, objects, components, data structures, etc., that perform particular tasks or implement particular abstract data types. Embodiments of the generalized kernel learning system 100 and method may also be practiced in distributed computing environments where tasks are performed by remote processing devices that are linked through a communications network. In a distributed computing environment, program modules may be located in both local and remote computer storage media including memory storage devices. With reference to FIG. 7, an exemplary system for embodiments of the generalized kernel learning system 100 and method includes a general-purpose computing device in the form of a computer 710 (the computing device 110 shown in FIG. 1 is an example of the computer 710).

Components of the computer 710 may include, but are not limited to, a processing unit 720 (such as a central processing unit, CPU), a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer readable media. Computer readable media can be any available media that can be accessed by the computer 710 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 710. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within the computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 781 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information (or data) into the computer 710 through input devices such as a keyboard 762, pointing device 761, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 720 through a user input interface 760 that is coupled to the system bus 721, but may be connected by other interface and bus structures, such as, for example, a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A computer-implemented method for learning a kernel to use in a support vector regression (SVR) technique, comprising:
inputting training data containing pairs of random variables;
reformulating a standard support vector machine (SVM) epsilon-insensitive SVR (ε-SVR) formulation for a single kernel as two reformulated primal cost functions for multiple kernels; and
performing support vector regression using at least one of the two reformulated primal cost functions for multiple kernels to obtain a kernel that yields a desired function that closely fits the training data and has a desired simplicity and smoothness.

2. The computer-implemented method of claim 1, further comprising reformulating one of the two reformulated primal cost functions for multiple kernels as a reformulated dual cost function.

3. The computer-implemented method of claim 2, further comprising computing a standard SVM ε-SVR dual formulation for a single kernel from the standard SVM ε-SVR primal formulation for a single kernel.

4. The computer-implemented method of claim 3, further comprising multiple kernelizing the standard SVM ε-SVR primal formulation for a single kernel to obtain an original primal cost function for multiple kernels.

5. The computer-implemented method of claim 4, further comprising reformulating the original primal cost function for multiple kernels as a first reformulated primal cost function and a second reformulated primal cost function.

6. The computer-implemented method of claim 5, further comprising computing a dual formulation for the second reformulated primal cost function to generate the reformulated dual cost function.

7. The computer-implemented method of claim 2, further comprising determining a regularizer and kernel combination that yields the desired function when evaluated using the reformulated dual cost function.

8. The computer-implemented method of claim 7, further comprising selecting any value for the kernel in the regularizer and kernel combination subject to a constraint that the kernel is strictly positive definite.

9. The computer-implemented method of claim 8, further comprising selecting any value for the kernel in the regularizer and kernel combination subject to the constraint that the kernel is differentiable with continuous derivative.

10. The computer-implemented method of claim 9, further comprising selecting any value for the regularizer in the regularizer and kernel combination subject to the constraint that the regularizer is differentiable with continuous derivative.

11. A method for finding a desired function that closely fits training data and has a desired simplicity using support vector regression (SVR), comprising:
reformulating a standard support vector machine (SVM) epsilon-insensitive SVR (ε-SVR) primal formulation for a single kernel to obtain a reformulated dual cost function for multiple kernels;
selecting any value of a kernel to use when evaluating the reformulated dual cost function for multiple kernels, the kernel subject to a constraint that the kernel is strictly positive definite; and
evaluating the selected kernel in the reformulated dual cost function for multiple kernels to obtain the desired function.

12. The computer-implemented method of claim 11, further comprising selecting the kernel subject to a constraint that the kernel is differentiable with continuous derivative.

13. The computer-implemented method of claim 12, further comprising selecting a regularizer and kernel combination that will yield the desired function when evaluated in the reformulated dual cost function for multiple kernels.

14. The computer-implemented method of claim 13, further comprising selecting the regularizer and kernel combination subject to a constraint that the regularizer is differentiable with continuous derivative.

15. The computer-implemented method of claim 11, further comprising:
multiple kernelizing the standard SVM ε-SVR primal formulation for a single kernel to obtain an original primal cost function for multiple kernels; and
reformulating the original primal cost function for multiple kernels as a first reformulated primal cost function and a second reformulated primal cost function.

16. The computer-implemented method of claim 15, further comprising computing a dual formulation for the second reformulated primal cost function to obtain the reformulated dual cost function.

17. A computer-implemented method for learning a kernel for evaluation in support vector regression (SVR) to obtain a desired function, comprising:
inputting training data having pairs of random variables;
reformulating a standard support vector machine (SVM) epsilon-insensitive SVR (ε-SVR) formulation for a single kernel as two reformulated primal cost functions for multiple kernels;
reformulating one of the two reformulated primal cost functions as a reformulated dual cost function;
selecting any regularizer and kernel combination that yields the desired function;
evaluating the regularizer and kernel combination using the reformulated dual cost function to obtain the desired function that closely fits the training data and has a desired simplicity; and
using the desired function in a machine learning application.

18. The method of claim 17, further comprising representing the reformulated dual cost function as:
$$W ( d ) = {Max}_{{α}^{\pm }} - \frac{1}{2} {( {α}^{-} - {α}^{+} )}^{t} K ( {α}^{-} - {α}^{+} ) + l ( d ) + {y}^{t} ( {α}^{-} - {α}^{+} ) - ε {1}^{t} ( {α}^{-} + {α}^{+} )$$
$$subject to$$
$${1}^{t} ( {α}^{-} - {α}^{+} ) = 0 , 0 \leq {α}^{\pm } \leq C .$$

19. The method of claim 18, further comprising selecting any kernel subject to constraints that the kernel is: (a) strictly positive definite; and (b) differentiable with continuous derivative.

20. The method of claim 19, further comprising selecting any regularizer to a constraint that the regularizer is differentiable with continuous derivative.
